(19) United States
(12) Patent Application Publication
(10) Pub. No.: US 2013/0062396 A1
(43) Pub. Date: Mar. 14, 2013

(54) METHOD OF FRICTION WELDING AXLES IN FINISHED FORM

(71) Applicants: Dean Davenport, Ingersoll (CA); Phillip David Schnurr, Ilderton (CA); Jules C. Guillemette, Woodstock (CA); John Norman Buggey, Dorchester (CA)

(72) Inventors: Dean Davenport, Ingersoll (CA); Phillip David Schnurr, Ilderton (CA); Jules C. Guillemette, Woodstock (CA); John Norman Buggey, Dorchester (CA)

(73) Assignee: IMT PARTNERSHIP

(21) Appl. No.: 13/615,206

(22) Filed: Sep. 13, 2012

Related U.S. Application Data
(60) Provisional application No. 61/534,310, filed on Sep. 13, 2011.

(51) Int. Cl. B23K 31/02; B23K 20/12

(52) U.S. Cl. 228/102

(57) ABSTRACT

A method of fabricating an axle for use on a truck body or trailer by machining and fully finishing, the components before friction welding results in an axle that is ready for use upon assembly of the components. Beam ends are friction welded to the main shaft with the longitudinal center axes of the kingpin bore holes being substantially the same orientation and preferably substantially within one degree of one another.

### BACKGROUND OF THE INVENTION

1. Field of the Invention

This invention relates to a method of fabricating axles for use on truck bodies or trailers of tractor trailers where the axles are fabricated in finished form using friction welding.

2. Description of the Prior Art

It is known to fabricate axles by partially machining and partially finishing a main shaft and beam ends the beam ends are then friction welded, one beam end at a time to the ends of the main shaft. The beam ends have a channel to ultimately receive a kingpin and the longitudinal axis of the two channels must be in substantial alignment with one another. Since the friction welding rotates the beam end and an end of the shaft relative to one another at high speed until the metal of the two mating surfaces becomes molten and the two components are welded together when the relative rotation stops and the components are cooled, the channels of the two beam ends have substantially different orientations. The channels of the two beam ends are only partially bored during the initial machining and partial finishing. After friction welding, the main shaft is then fully machined and fully finished by completing the boring of the channels of the beam ends to ensure that he longitudinal axes of the channels are aligned with one another. The knuckle assemblies are partially machined and partially finished by friction welding a knuckle portion and a spindle portion to one another. After friction welding, the knuckle assemblies are then finished machined. One fully finished knuckle assembly is then affixed to each of the two fully finished beam ends. Additional components to complete the partially machined and partially finished axle are added including a steering arm. The finished axle is then ready for use. The axle can be an in line kingpin axle or a self steering axle.

### SUMMARY OF THE INVENTION

It is an object of the present invention to provide a method of fabricating an axle by firstly fully machining and fully finishing all of the components and particularly fully machining and fully finishing the main shaft and the two beam ends prior to friction welding. It is a further object of the present invention to friction weld the two beam ends in finished form to the ends of the main shaft in finished form so that a longitudinal center of a channel of the two beam ends are substantially aligned with one another.

A method of fabricating an axle in finished form for use on a truck body or trailer using a friction welding machine, the trailer being connectable to a road tractor uses an axle having a main shaft with two opposing ends, two beam ends and two knuckle assemblies. The beam ends each contain a channel having a longitudinal centre axis. The method comprises fully machining and fully finishing the main shaft and the two beam ends, creating a computer program to appropriately control the friction welding machine, inputting the program into the machine, operating the machine to friction weld the beam ends to the opposing ends of the main shaft and causing the machine to stop rotating each beam end relative to the main shaft so that the longitudinal centre axes of the channels of the beam ends have substantially the same orientation relative to the main shaft, and attaching fully finished knuckle assemblies to the beam ends to produce the axle in finished form ready for use after attaching other fully finished components including a steering rod.

Preferably, the method further comprises machining and fully finishing a knuckle portion and a spindle portion for each of the knuckle assemblies and friction welding the spindle portion to the knuckle portion to produce a fully finished knuckle assembly and repeating the process for a second knuckle assembly.

Preferably, the orientation of the longitudinal centre axes of the channels of the two beam ends is substantially within one degree of one another.

### BRIEF DESCRIPTION OF THE DRAWINGS

FIG. 1 is a perspective view of a main shaft;

FIG. 2 is a perspective view of a beam end when viewed from an end face;

FIG. 3 is a perspective view of a beam end when viewed from a kingpin bore;

FIG. 4 is a sectional end view of the beam end when viewed from the kingpin bore;

FIG. 5 is a perspective view of the main shaft with two beam ends friction welded thereto;

FIG. 6 is a perspective view of a knuckle portion and viewed from an outer face;

FIG. 7 is a perspective view of a knuckle portion when viewed from an inside face;

FIG. 8 is a perspective view of spindle portion when viewed from an inner face;

FIG. 9 is a perspective view of a knuckle assembly when viewed from a spindle portion;

FIG. 10 is a perspective view of a knuckle assembly when viewed from the knuckle portion;

FIG. 11 is a perspective view of an in line kingpin axle a view from the side of the steering rod;

FIG. 12 is a perspective view of an in line kingpin axle when viewed from an opposite side from the steering rod;

FIG. 13 is a perspective view of a further embodiment of an inline kingpin axle;

FIG. 14 is a perspective view of a beam end of a self steering axle when viewed from an end face;

FIG. 15 is a perspective view of the beam end when viewed from a kingpin bore;

FIG. 16 is a sectional side view of the beam end when viewed from the kingpin bore;

FIG. 17 is a perspective view of the main shaft with two beam ends of the self steer axle friction welded thereto;

FIG. 18 is a perspective view of a knuckle portion when viewed from an inside;

FIG. 19 a perspective view of a knuckle portion when viewed from an outer face;

FIG. 20 is a perspective view knuckle assembly for a self steer axle when viewed from a spindle portion;

FIG. 21 is a perspective view of a self steer axle when viewed from a side of the steering rod; and

FIG. 22 is a perspective view of the self steer axle when viewed from a side opposite to the steering rod.

### DETAILED DESCRIPTION OF A PREFERRED EMBODIMENT

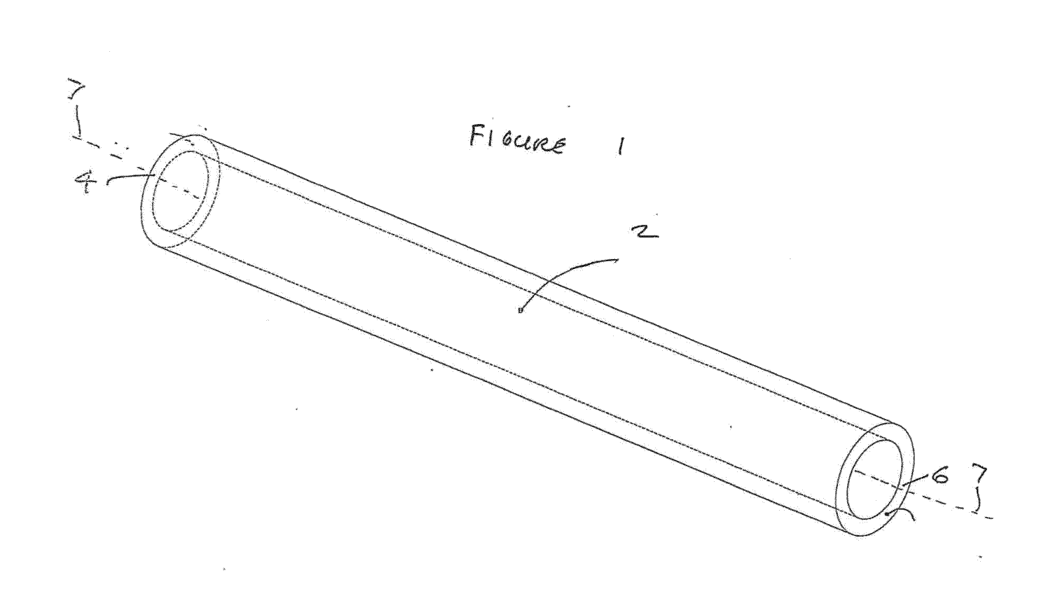

In FIG. 1, there is shown a perspective view of a main shaft 2 having two ends 4, 6. The main shaft is hollow and has a cylindrical shape, but other shapes will be suitable and the main theft can be solid rather than hollow. The main shaft 2 has a longitudinal centre axis 7.

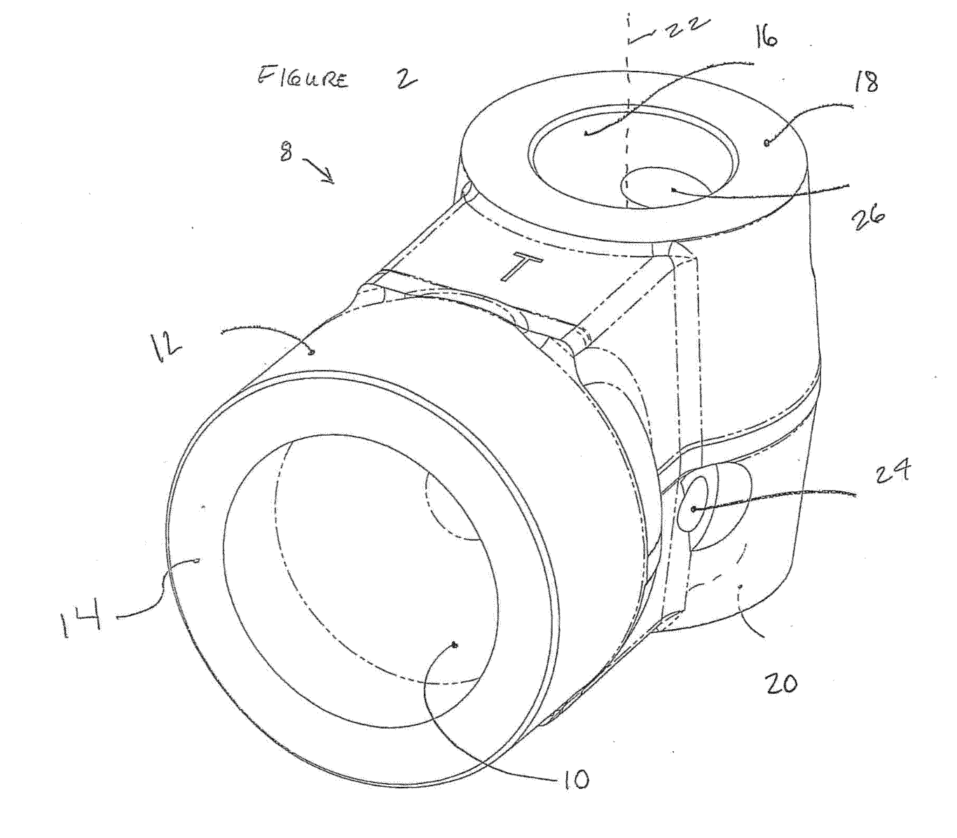

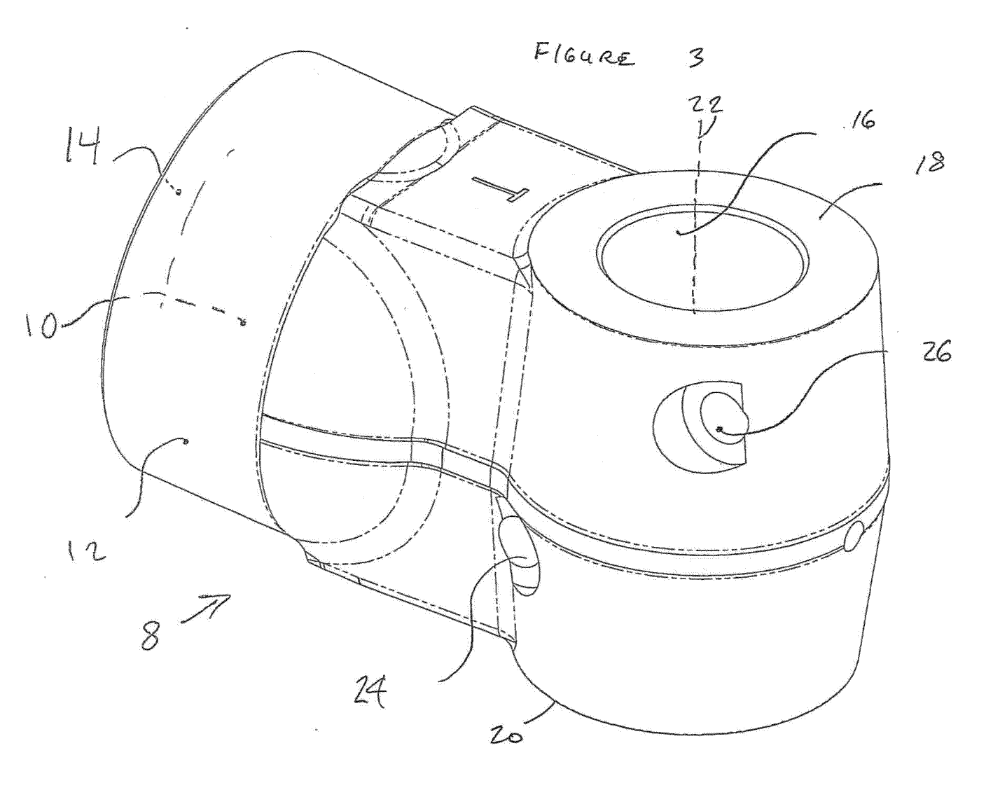

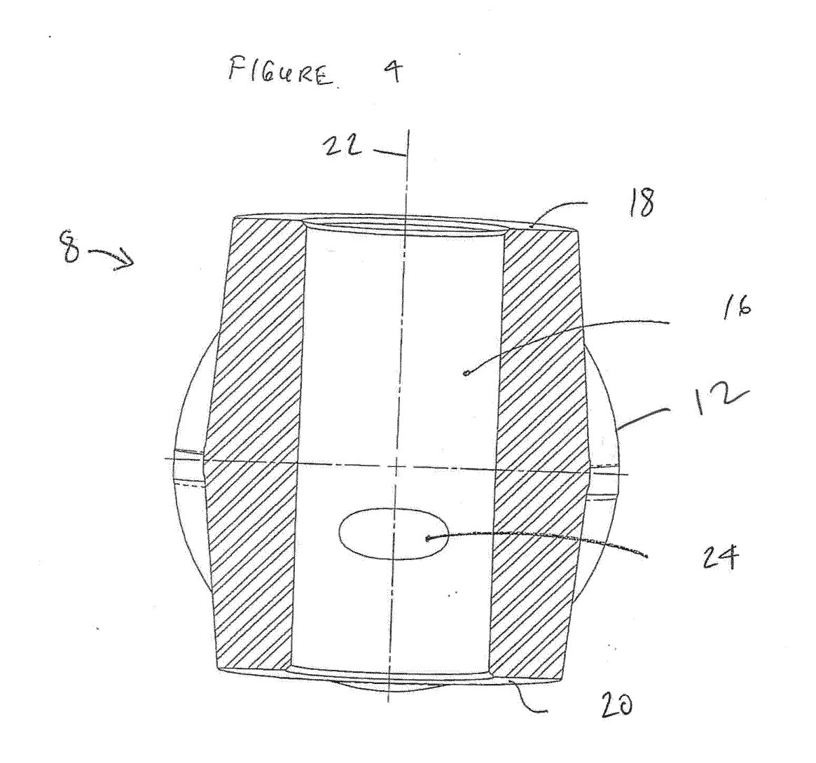

In FIGS. 2 and 3, there are shown perspective views of the beam end 8. FIG. 4 is a sectional end view of the beam end 8. There are two beam ends 8 (only one of which is shown in FIGS. 2, 3 and 4). Each beam end 8 has a cavity 10 with an outer diameter 12 and a contact face 14. The beam end 8 has a kingpin bore 16 with a top face 18 and bottom face 20. The kingpin bore has a longitudinal center axis 22 with draw key holes 24, 26. The kingpin bore 16 is a channel of the beam end 8.

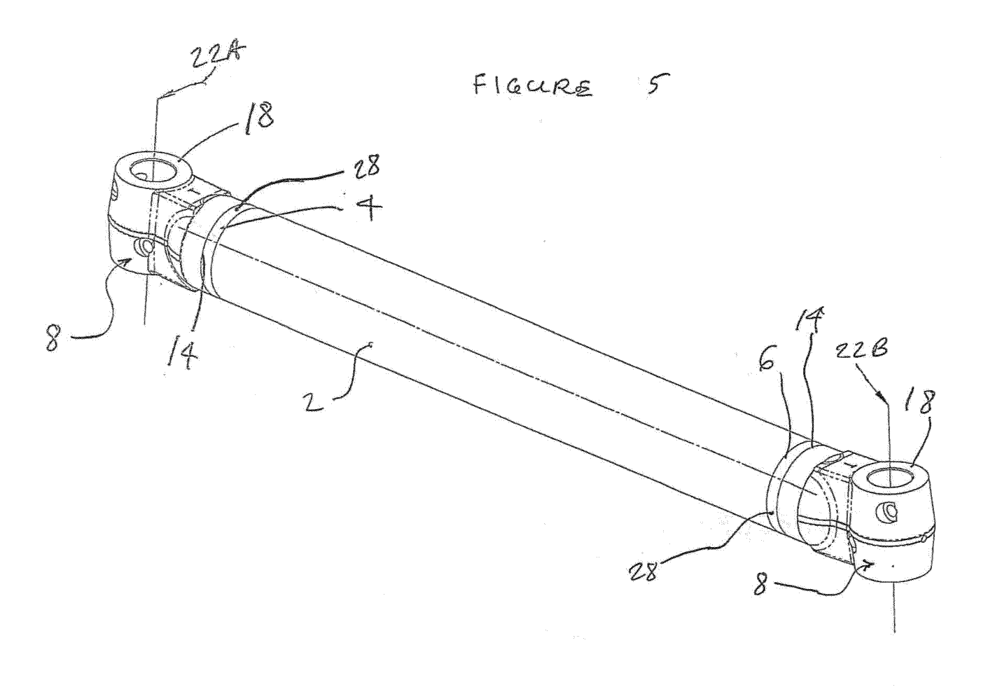

In FIG. 5, there are two beam ends 8, one beam end 8 being friction welded to each end 4, 6 of the main shaft 2. The contact face 14 of each beam end 8 is friction welded to the ends 4, 6 of the main shaft 2. The friction welds are designated 28 and the longitudinal centre axes of the kingpin bores 16 of the two beam ends 8 are designated 22A and 22B.

Prior to friction welding the beam ends to the shaft, the main shaft 2 and the beam ends 8, including the kingpin bores 16 are machined and fully finished. The beam ends can be friction welded to the main shaft in a friction welding machine (not shown) simultaneously or one beam end at a time. It is essential that the friction welding of the beam ends 8 to the main shaft 2 be completed with the longitudinal center axes 22A and 22B of the two beam ends having substantially the same orientation relative to the main shaft. During the friction welding process, the main shaft is usually held in a fixed position and the two beam ends 8 are rotated rapidly relative to the ends of the main shaft until the ends 4, 6 and the contact faces 14 of the beam ends 8 are hot enough for friction welding to occur. While the metal of the shaft ends and the contact faces is still molten, the rotation of the beam ends is stopped so that the longitudinal center axes 22A and 22B of the kingpin bore of each beam end 8 have substantially the same orientation relative to the main shaft. Preferably, the orientation of the longitudinal center axes of the kingpin bores of the beam ends is substantially within one degree of one another and still more preferably is within one degree of one another. When the beam ends are friction welded to the main shaft one after the other (in succession), it is essential that the second beam end be friction welded with the longitudinal axis of the kingpin bore having substantially the same orientation relative to the longitudinal axes of the kingpin bore of the beam end that was first friction welded.

The friction welding machine is controlled by a programmable controller. A computer program is created and inputted into the friction welding machine to cause the machine to stop rotating each beam end relative to the main shaft so that the longitudinal axes of the kingpin bores of the two beam ends have substantially the same orientation. This step can be accomplished by driving the friction welding machine against the braking mechanism of the welding machine so that the rotation can be stopped quickly at precisely the correct time.

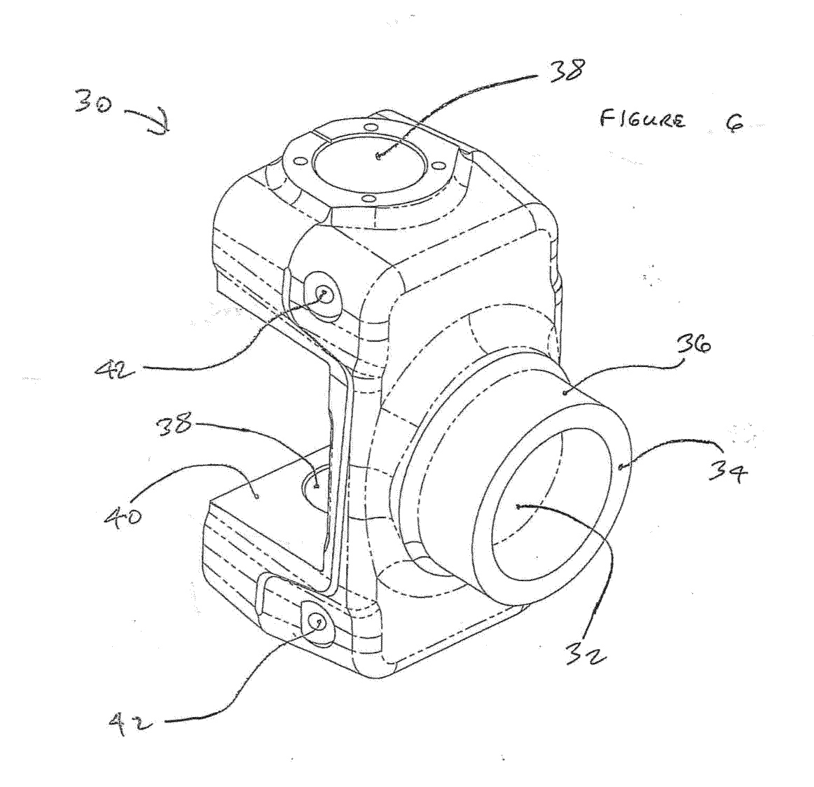

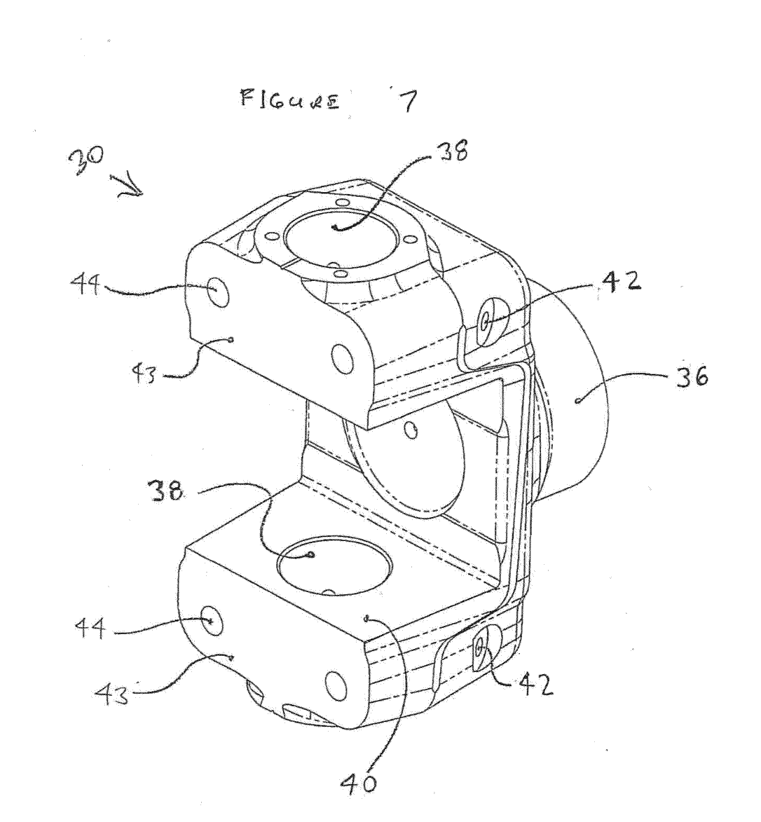

In FIGS. 6 and 7, there are shown two perspective views of a knuckle portion 30. As with the beam ends 8, there are two knuckle portions 30 (only one of which is shown) and each knuckle portion 30 has a cavity 32 with a face 34 and an outside diameter 36. Knuckle portion 30 has upper and lower bores 38 and a vertical bearing area 40 and grease fitting holes 42. The knuckle portions 30 are machined and fully finished. A face 43 on a side opposite to the cavity has bolt holes 43 therein.

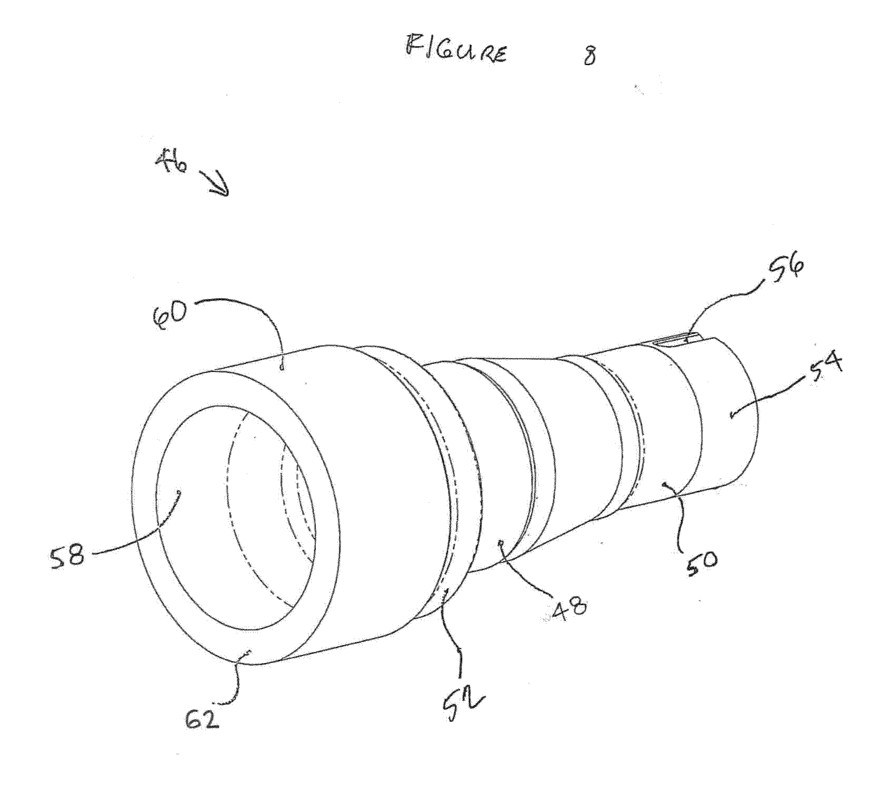

In FIG. 8, there is shown a spindle 46 that is also machined and fully finished. There are two spindles 46 (only one of which is shown in FIGS. 8, 9 and 10) and each spindle has bearing journals 48, 50, a seal journal 52, a thread 54 and a keyway 56. The spindle has a cavity 58, with an outside diameter 60 and a face 62.

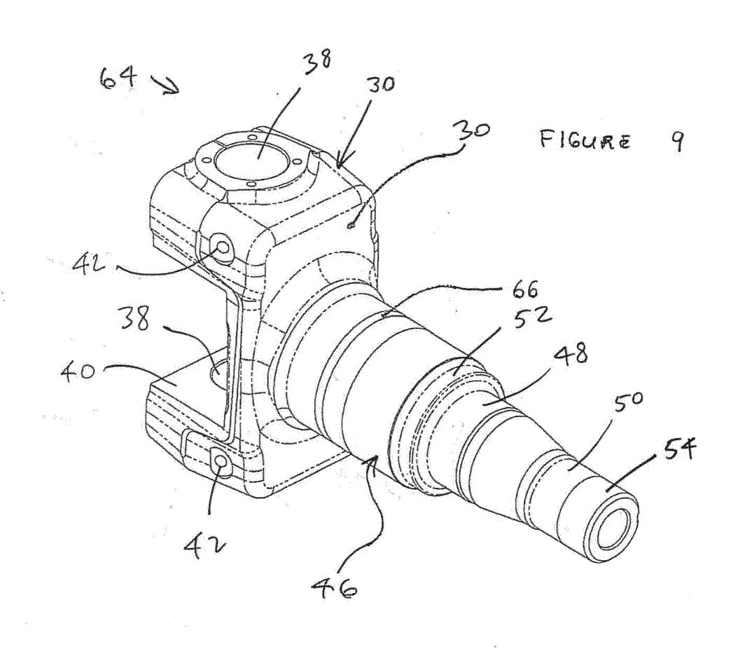

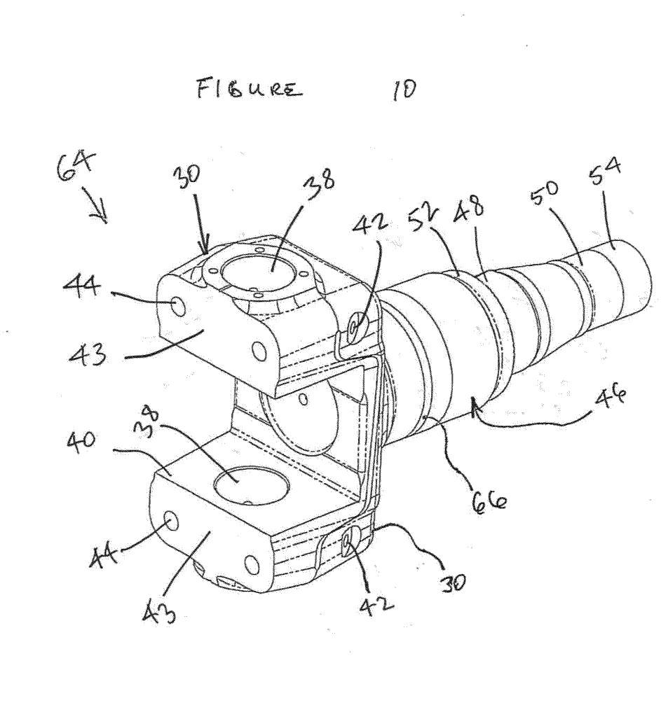

The face 34 of the knuckle portion 30 and the face 62 of the spindle 46 are sized to be friction welded to one another to produce a knuckle assembly 64 as shown in FIGS. 9 and 10. The knuckle assembly 64 can be fabricated before or after the beam ends 8 are friction welded to the main shaft 2 and, preferably, the knuckle assemblies 64 are also friction welded and have a friction weld 66. The two faces 34, 62 become molten and are formed into the weld 66 during friction welding.

Since the knuckle portions 30 and the spindles 66 are machined and fully finished before being welded to produce the knuckle assemblies 64, the knuckle assemblies are completely machined and fully finished as soon as they are welded.

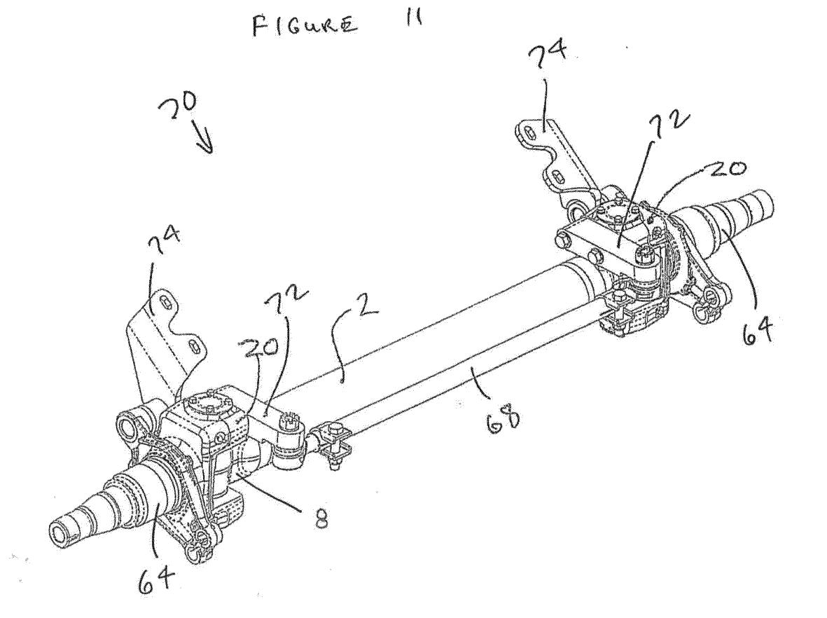

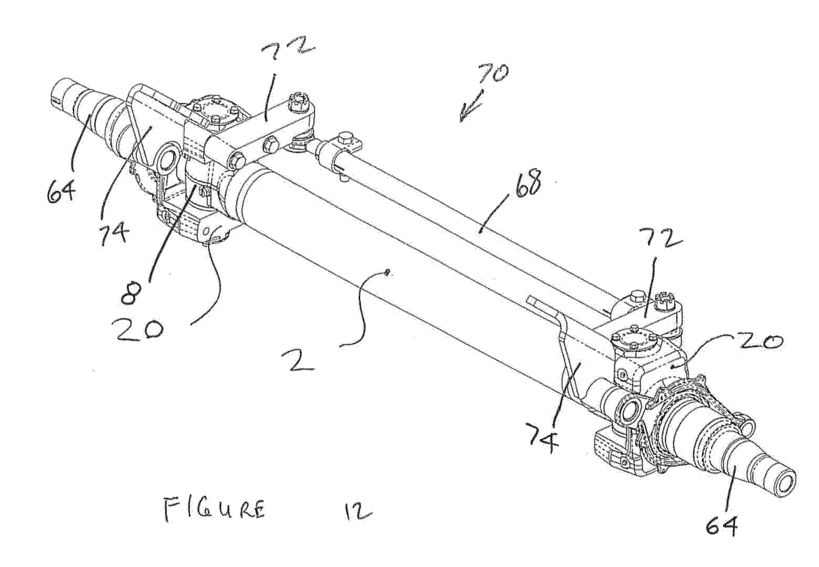

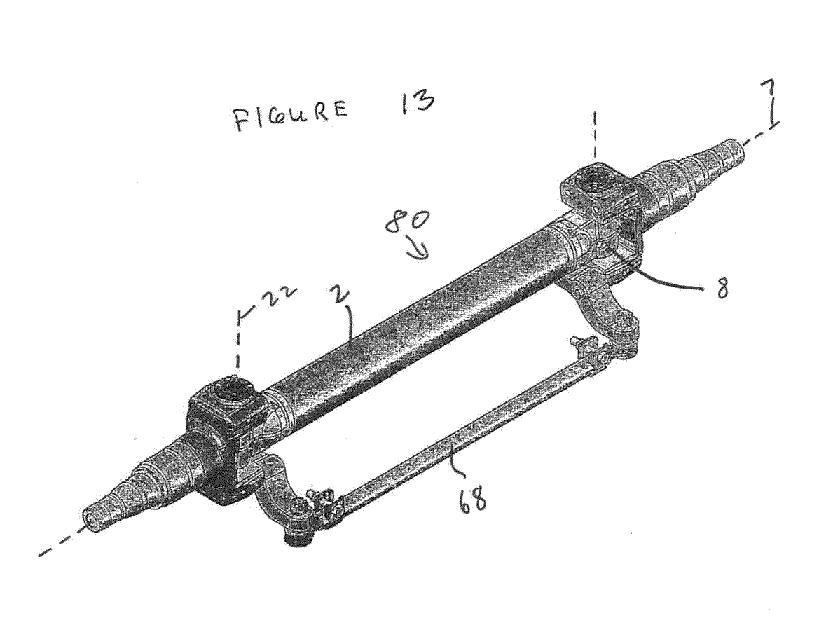

After the beam ends 8 are friction welded to the main shaft 2, the fully finished knuckle assemblies 64 are connected to the beam ends 8 along with other fully finished components including a tie rod 68 to produce a machined and fully finished in line kingpin axle 70 as shown in FIGS. 11 and 12. The steering rod 68 is pivotally held In place by bracket 72 and is conventional, Hanger brackets (not shown) are welded to the axle 2 and are used to connect the axle 70 to the suspension and frame (not shown) of the trailer (not shown). The axle 70 also has a brake actuator (not shown) and a mechanical lock (not shown). Brake actuator brackets 74 are conventional. The other fully finished components that are affixed to the axle 70, after the friction welding of the beam ends and the connection of the knuckle assemblies to the beam ends, are conventional arid are therefore not described in great detail. FIG. 13 is a perspective view of a further embodiment of an in line kingpin axle 80. The longitudinal centre axis 7 of the main shaft 2 of the in line kingpin axles 70, 80 intersects the longitudinal centre axes of the kingpin bores 16 after the beam ends 8 are friction welded to the main shaft 2. The knuckle assemblies 64 pivot relative to the shaft 2 as the vehicle (not shown), in which the suspension axle is installed, turns.

For some uses, a spacer having two end faces is friction welded between the knuckle portion 30 and the spindle 46 to provide a greater overall length to each knuckle assembly and therefore to the finished axle.

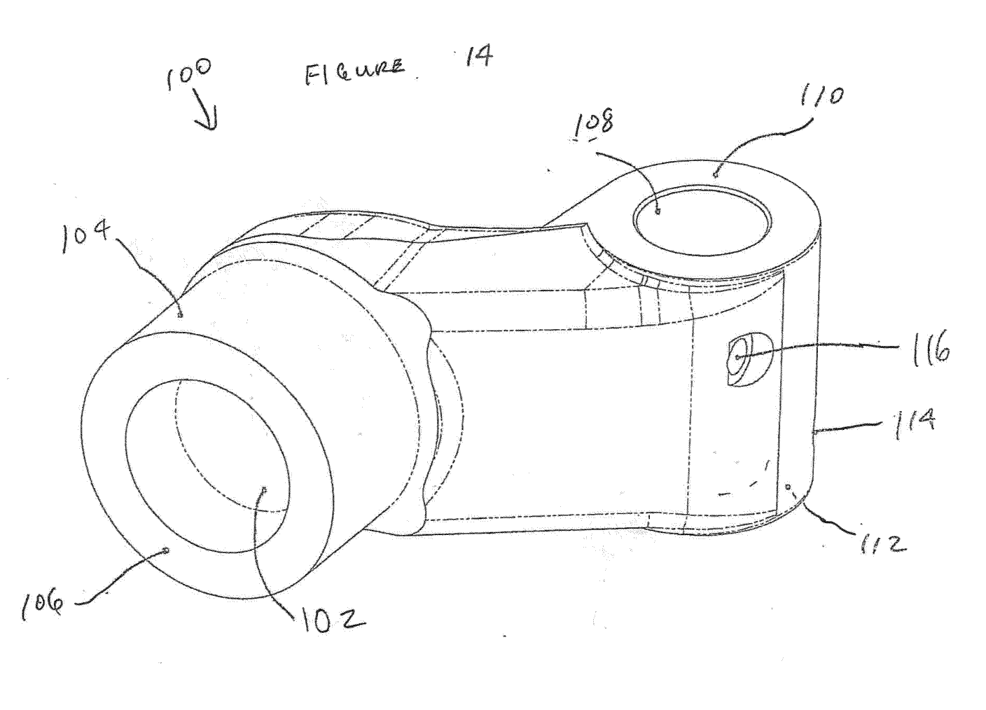

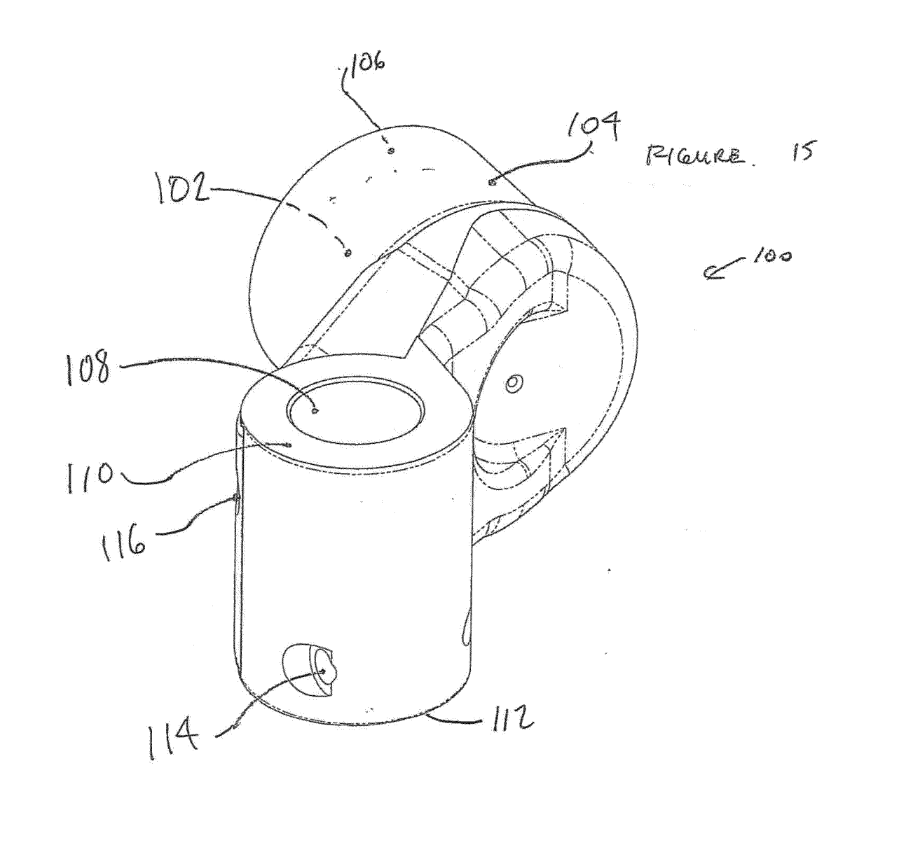

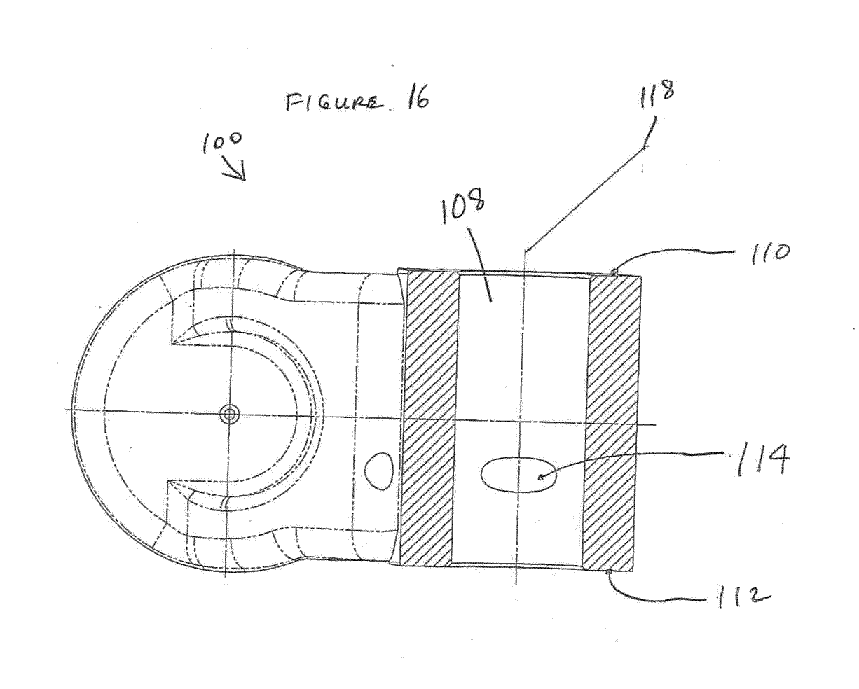

In FIGS. 14 to 20, there is shown a further embodiment of the invention. In FIGS. 14, 15 and 16, there are shown perspective views of beam ends 100 for a self steer axle (not shown in FIGS. 14 and 15). The beam end 100 has a cavity 102 having an outer diameter 104 and a contact face 106 at one end and a kingpin bore 108 having a top face 110 and a bottom face 112. The kingpin bore 108 has draw key holes 114 and 116. In FIG. 16, it can be seen that the kingpin bore 108 has a longitudinal centre axis 118. The kingpin bore 108 is shown in section and there are two beam ends 100, only one of which is shown in FIGS. 14 to 16.

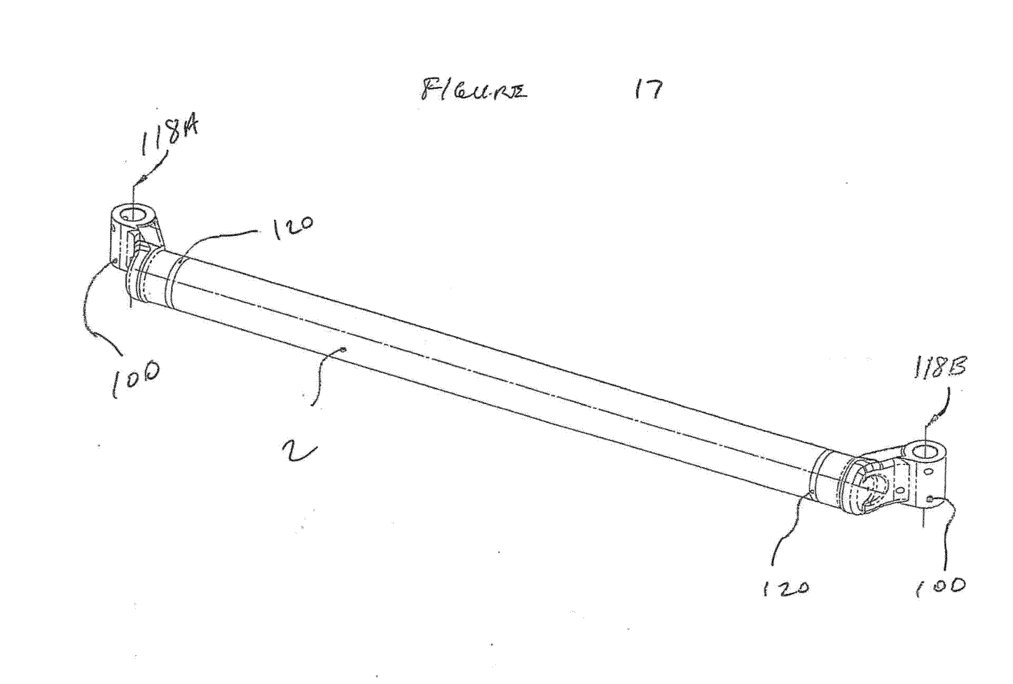

In FIG. 17, the beam ends 100 are friction welded to the main shaft by friction welds 120. The two beam ends 100 have longitudinal axes 118A and 118B with substantially the same orientation relative to the main shaft 2 and preferably the orientation of the longitudinal axes 118A, 118B is within one degree of one another. The same friction welding process is used as described above with respect to the main shaft 2 and the beam ends 8 and the main shaft 2 and the beam ends 100 are fully machined and fully finished before commencing the friction welding process.

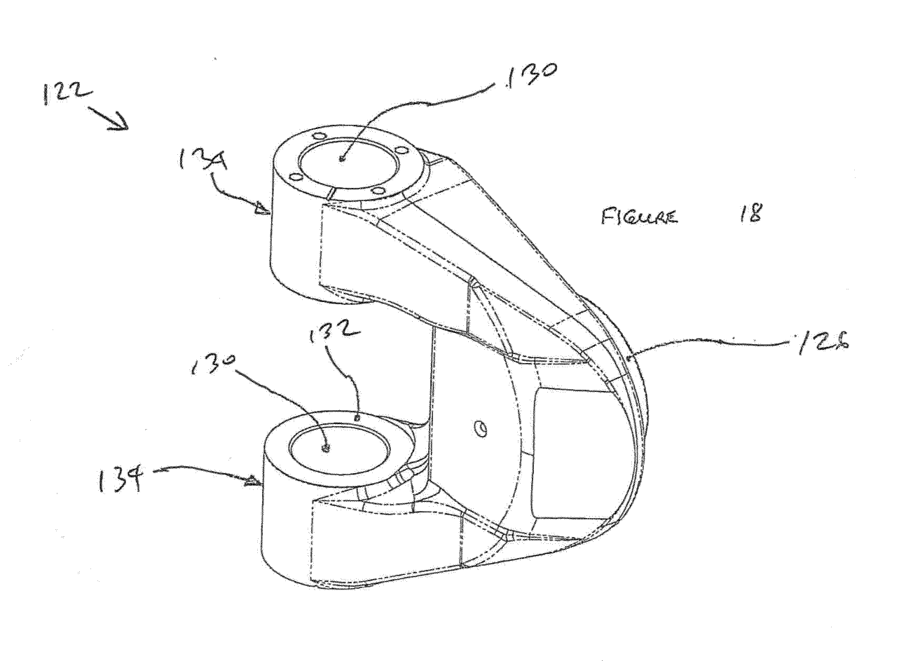

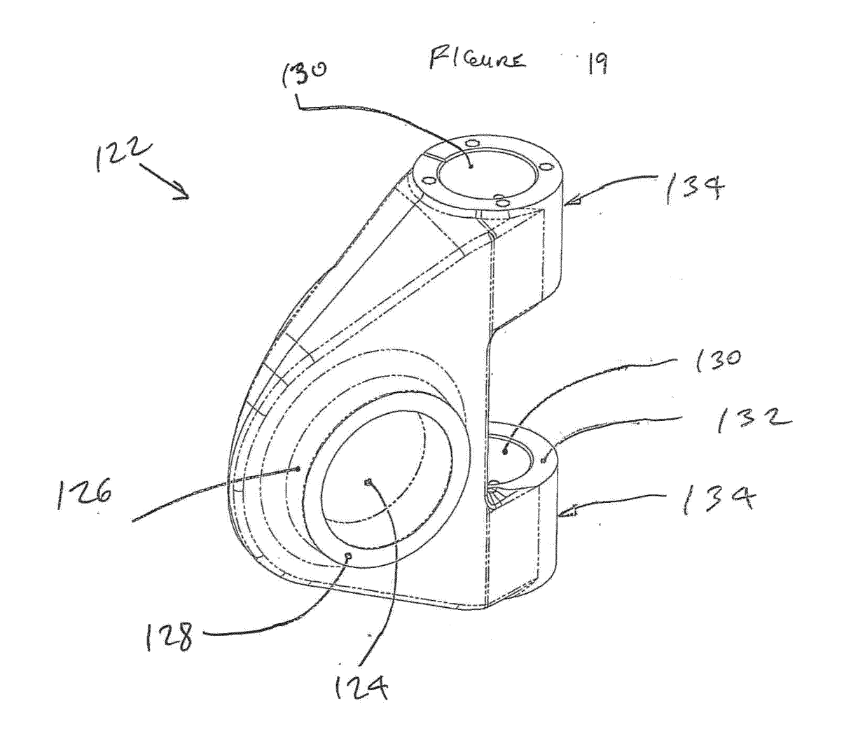

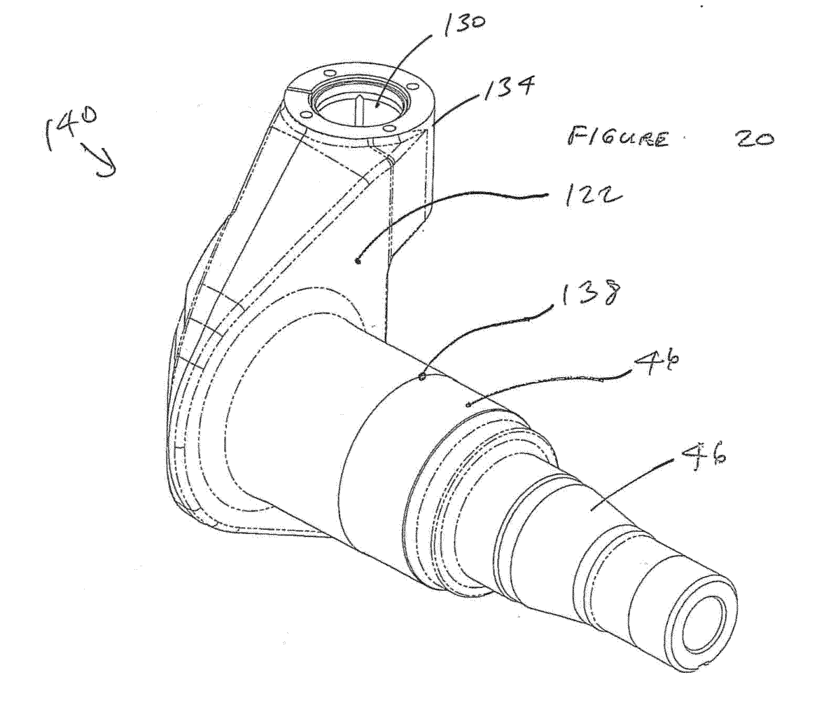

In FIGS. 18 and 19, there are shown perspective views of a knuckle portion 122. The knuckle portion 122 has a cavity 124, an outside diameter 126 and a contact face 128 with a bore 130 to receive a kingpin (not shown). The bore 130 has a finished vertical bearing area 132 and grease fitting holes 134, The knuckle portion 122 is machined and fully completed before beginning to friction weld the knuckle portion 122 to the spindle 46. The spindle 46 is also machined and fully finished before the friction welding process. The spindle 40 is preferably friction welded to the knuckle portion 122 in an area along the line 138 to produce a knuckle assembly 140 as shown in FIG. 20.

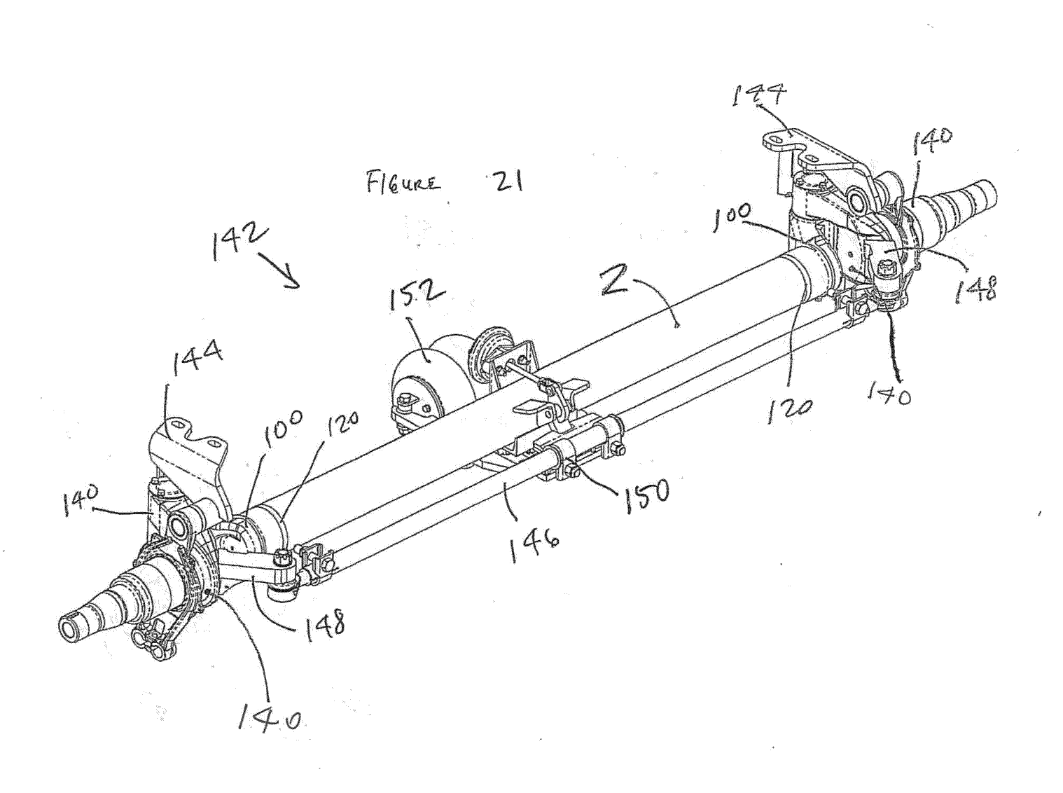

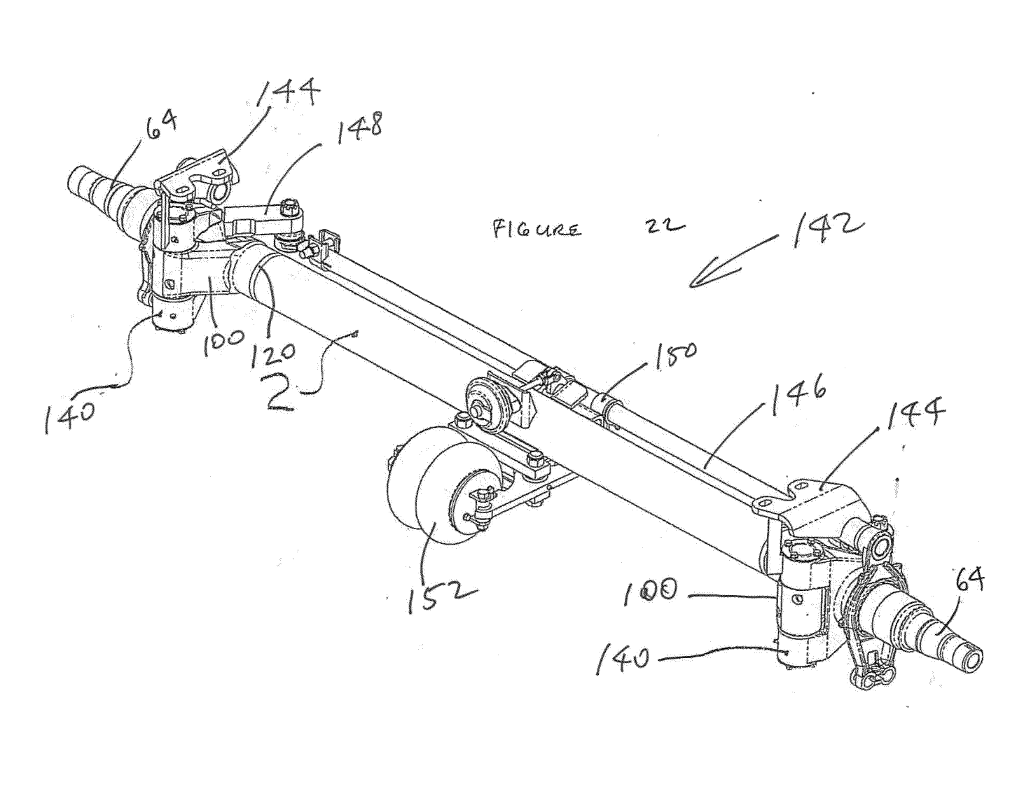

In FIGS. 21 and 22, there are perspective views of a self steering axle 142. The two knuckle assemblies 140 are connected to the beam ends 100. The other fully finished components including brake actuator brackets 144, tie rod 146, brackets 148, 150 supporting the tie rod 146 and bellows 152. These additional finished components are conventional and are not described in great detail. The same reference numerals era used in FIGS. 21 and 22 to describe those components that are identical to the components in FIGS. 1, 8 and 14 to 20.

Numerous variations can be made to the axles that are the subject matter of this invention. The friction welded components do not overlap but are sized to fit face to face to one another. [00] The friction welds provide a high quality solid and durable weld that allows for lighter materials to be used for the friction welded components without sacrificing strength or durability. Advantages that can be achieved by machining and fully finishing the components before friction welding occurs is that the axles can be fabricated in, fewer steps resulting in significant costs savings in addition to producing a superior product. If the kingpin bore holes of the two beam ends do not have substantially the same orientation after being friction welded to the main shaft, the shaft and beam ends are not useable and must be discarded.

We claim:

1. A method of fabricating an axle in finished form for use on a tractor, truck body, or trailer using a friction welding machine, the trailer being connectable to a road tractor, the axle having a main shaft with two ends, two beam ends and two knuckle assemblies, the beam ends each containing a channel having a longitudinal centre axis, the method comprising fully machining and fully finishing the main shaft and the two beam ends, creating a computer program to appropriately control the friction welding machine, inputting the program into the machine, operating the machine to friction weld the beam ends to the opposing ends of the main shaft and causing the machine to stop rotating each beam end relative to the main shaft on so that the longitudinal centre axes of the channels of the beam ends have substantially the same orientation relative to the main shaft, and attaching fully finished knuckle assemblies to the beam ends to produce the axle in finished form ready for use after attaching other fully finished components including a steering rod.

2. A method as claimed in claim 1 including the steps of using a programmable controller to control the machine and inputting the program into the controller.

3. A method as claimed in claim 2 including the steps of driving the friction welding machine against a braking mechanism of the welding machine when friction welding the beam ends.

4. A method as claimed in claim 3 including the steps of fabricating each of the knuckle assemblies by machining and fully finishing a knuckle portion and a spindle portion for each of the knuckle assemblies, friction welding the spindle portion to the knuckle portion to produce a fully finished knuckle assembly and repeating the method to produce a second knuckle assembly of the two knuckle assemblies.

5. A method as claimed in any one of claim 1, 2 or 3 including the steps of friction welding the beam ends to each end of the shaft so that an orientation of the longitudinal centre axes of the channels of the beam ends is within one degree of one another.

6. A method as claimed in any one of claim 1, 2 or 3 including the steps of friction welding the beam ends to the ends of the main shaft without any overlap between the ends and the shaft.

7. A method as claimed in any one of claims 1, 2 or 3 including the steps of friction welding the beam ends to the ends of the main shaft of an in line kingpin axle so that a longitudinal centre axis of the main shaft extends through the longitudinal centre axes of the beam ends.

8. A method as claimed in claim 2 including the steps of friction welding a spacer between the knuckle portion and spindle portion of each knuckle assembly to lengthen each knuckle assembly.

9. A method as claimed in any one of claims 1, 2 or 3 including the steps of friction welding one beam end onto one end of the main shaft and subsequently friction welding another beam end onto an apposite end of the main shaft.

10. A method as claimed in any one of claims 1, 2 or 3 including the steps of friction welding the beam ends onto either end of the main shaft simultaneously.

11. A method as claimed in any one of claims 1, 2 or 3 including the steps of adding an actuator and mechanical lock.

12. A method as claimed in any one of claims 1, 2 or 3 including the steps of fabricating an axle selected from the group of an in line kingpin axle and a self steering axle.
